(19) United States
(12) Patent Application Publication
(10) Pub. No.: US 2011/0269622 A1
(43) Pub. Date: Nov. 3, 2011

(54) THERMOSENSITIVE RECORDING MEDIUM

(76) Inventors: Katsuto Ohse, Tokyo (JP); Yoshimi Midorikawa, Tokyo (JP); Akihito Ogino, Tokyo (JP); Keiichirou Inada, Fukuoka (JP); Yoshimune Aosaki, Fukuoka (JP)

(21) Appl. No.: 12/934,230

(22) PCT Filed: Mar. 27, 2009
(86) PCT No.: PCT/JP2009/056306

§ 371 Date: Jul. 22, 2011

(30) Foreign Application Priority Data
Mar. 27, 2008 (JP) 2008-082787

(51) Int. Cl. B41M 5/333; B41M 5/323

(52) U.S. Cl. 503/216

(57) ABSTRACT

The present invention provides a thermosensitive recording medium having an excellent image durability, even when used in a severe condition.

A thermosensitive recording medium having a thermosensitive color developing layer comprising a colorless or pale colored dye and two kinds of color developing agents on a substrate, wherein the thermosensitive color developing layer contains bis (3-allyl-4-hydroxyphenyl) sulfone and a phenol novolac compound as the color developing agents.

### FIELD OF THE INVENTION

The present invention relates to a thermosensitive recording medium that utilizes a color formation reaction between an electron donating leuco dye and an electron accepting color developing agent and more particularly to a thermosensitive recording medium having excellent color developing sensitivity, plasticizer resistance in image area, light resistance and heat resistance.

### BACKGROUND OF THE INVENTION

A thermosensitive recording medium containing a thermosensitive color developing layer, the major component of which is an electron accepting color developing agent (henceforth referred to as “color developing agent”) that develops color when heated with a colorless or pale colored electron donating leuco dye (henceforth referred to as “dye”), is widely used. A thermal printer and the like in which a thermal head is contained is used to record on the thermosensitive recording medium. This recording method has many feature such as low maintenance, low-cost, compact size, clear color development, etc. as compared with other recording methods. Therefore, it is used extensively in facsimile machines, computer printers, automatic ticket vending machines, measurement recorders, handy outdoor terminals and the like. The thermosensitive recording medium is used not only as the output paper in the various devices mentioned above but is also becoming popular for use in applications such as vouchers and the like where excellent durability is required.

When a thermosensitive recording medium is used for various tickets, receipts, labels, bank ATM print outs, gas and electrical meter read outs and vouchers such as horse racing tickets and the like, the medium needs to have plasticizer resistance, to avoid the problem of printed letter readability when the medium is stored for an extended period of time in contact with a film or synthetic leather, and light resistance and heat resistance to prevent fading when the medium is exposed to sunlight for an extended period of time.

For these reasons, a thermosensitive recording medium prepared by using, as the color developing agent, bis(3-allyl-4-hydroxyphenyl) sulfone (Reference 1), a phenolic condensation compound (Reference 2) and a combination of a phenolic condensation compound and other color developing agent, sensitizer or stabilizer (References 3) and the like have been disclosed.
Reference 1: Japanese Patent Application Public Disclosure No. H04-164687
Reference 2: Japanese Patent Application Public Disclosure No. 2003-154760
Reference 3: International Publication WO 2005/087503

### Problems to be Solved by the Invention

However, thermosensitive recording media have been more frequently used in severe condition, such as those of vouchers and the like, recently and better image durability than before has been required. Thermosensitive recording media with a sufficient quality in these properties are not available at the moment. And when a thermosensitive recording medium has a protective layer, the thermosensitive recording media become to have another problems, such as poor color developing sensitivity and poor image quality. Therefore, the objective of the present invention is to provide a thermosensitive recording medium having a superior image durability even when used in a severe condition.

### Means to Solve the Problems

The inventors discovered as a result of an intense study that the objective can be attained by a thermosensitive recording medium with a thermosensitive color developing layer comprising two kinds of specific color developing agents. The present invention was completed based on the discovery.

That is, the present invention is a thermosensitive recording medium having a thermosensitive color developing layer comprising a colorless or pale colored electron donating leuco dye and an electron accepting color developing agent on a substrate, wherein the thermosensitive color developing layer contains

(1) bis(3-allyl-4-hydroxyphenyl) sulfone as a first electron accepting color developing agent, and
(2) a condensation composition represented by the chemical formula 1 as a second electron accepting color developing agent:

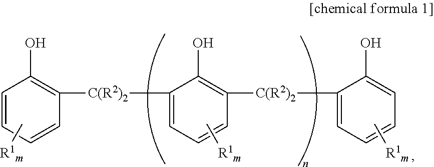

wherein R¹, which may be identical to or different from the others, represents a hydrogen atom, a halogen atom, a hydroxyl group, a lower alkyl group, an alkoxyl group, a cyano group, a nitro group, an aryl group or an aralkyl group, R², which may be identical to or different from the others, represents a hydrogen atom, an alkyl group or an aryl group, m represents an integer of 0 to 3 and n represents an integer of 0 to 3,
wherein the weight ratio of the first electron accepting color developing agent to the second electron accepting color developing agent is more than 1 and less than or equal to 4.

### DETAILED DESCRIPTION OF THE INVENTION

The present invention is described in further detail below.

The thermosensitive color developing layer of the thermosensitive recording medium of the present invention comprises a color developing agent and a dye and the thermosensitive color developing layer contains bis(3-allyl-4-hydroxyphenyl) sulfone and a phenol novolac compound as the color developing agent.

Bis (3-allyl-4-hydroxyphenyl) sulfone is known as a color developing agent that can impart a good plasticizer resistance, but brings a poor color developing sensitivity. On the other hand, phenol novolac compound is known as a color developing agent that can impart a good color developing sensitivity, but brings a problematic plasticizer resistance. In the thermosensitive color developing layer of the present invention, when using bis (3-allyl-4-hydroxyphenyl) sulfone (a first electron accepting color developing agent) in an excess amount to that of a phenol novolac compound (a second electron accepting color developing agent), especially when using these with the weight ratio of the first electron accepting color developing agent to the second electron accepting color developing agent is more than 1 and less than or equal to 4, it is considered that the stability of the charge-transfer complex that is a reaction product of a color developing agent and a basic dye is good, then each problem of these that appears when one of these is used solely is solved and both advantages are not hampered, which brings a high color developing sensitivity and a good plasticizer resistance.

The first color developing agent of the present invention is bis(3-allyl-4-hydroxyphenyl) sulfone.

The phenol novolac compound, which is the second color developing agent of the present invention, is represented by the chemical formula 2.

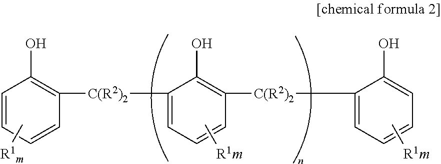

wherein R¹, which may be identical to or different from the others, preferably be identical to the others, represents a hydrogen atom, a halogen atom, a hydroxyl group, a lower alkyl group, an alkoxyl group, a cyano group, a nitro group, an aryl group or an aralkyl group. Among these, R¹ represents preferably a lower alkyl group or an aralkyl group, more preferably a lower alkyl group.

As the lower alkyl group, preferred is a tertiary lower alkyl group, and the number of carbon atoms is preferably 1 to 5, more preferably 1 to 4. The lower alkyl group includes, for example, methyl, ethyl, n-propyl, isopropyl, n-butyl, t-butyl, and t-amyl groups or the like.

The number of carbon atoms of the alkoxy group is preferably 1 to 5 and the alkoxy group includes, for example, methoxy, ethoxy, propoxy, isopropoxy, butoxy, t-butoxy groups and the like.

The aryl group includes, for example, phenyl, tolyl, naphthyl group and the like, preferably phenyl group. In addition, the aralkyl group includes, for example, cumyl group, o-methylbenzyl group and the like.

R², which may be identical to or different from the others, preferably be identical to the others, represents a hydrogen atom, an alkyl group or an aryl group. And it is preferable that at least one of two R² that bind to the same carbon atom is a hydrogen atom, and it is more preferable that both R² that bind to the same carbon atom are hydrogen atoms.

The number of carbon atoms of the alkyl group is preferably 1 to 5, more preferably 1 to 4. The alkyl group includes, for example, methyl, ethyl, n-propyl, isopropyl, n-butyl, t-butyl and the like.

The aryl group includes, for example, phenyl, tolyl, naphthyl group and the like, preferably a phenyl group.

“n” represents an integer of 0 to 3. The condensation composition represented by the chemical formula 2 includes each condensation product with n is 0, 1, 2 or 3 and the mixture of at least two of these four kinds of condensation products.

“m” represents an integer of 0 to 3, preferably an integer of 1 to 3, more preferably 1. When m is an integer of 1 to 3, R¹ preferably locates in meta or para position to the hydroxyl group in the phenol group and more preferably locates in para position to the hydroxyl group in the phenol group.

The specific examples of the two ring condensation product of the condensation composition represented by the chemical formula 2, which is a condensation product with n=0 having two phenol rings, may include, for example, 2,2′-methylene bisphenol, 2,2′-methylene bis(4-chlorophenol), 2,2′-methylene bis(5-chlorophenol), 2,2′-methylene bis(4-hydroxyphenol), 2,2′-methylene bis(5-hydroxyphenol), 2,2′-methylene bis(4-methylphenol), 2,2′-methylene bis(5-methylphenol), 2,2′-methylene bis(4-ethylphenol), 2,2′-methylene bis(5-ethylphenol), 2,2′-methylene bis(4-n-propylphenol), 2,2′-methylene bis(4-isopropylphenol), 2,2′-methylene bis(5-n-propylphenol), 2,2′-methylene bis(5-isopropylphenol), 2,2′-methylene bis(4-n-butylphenol, 2,2′-methylene bis(4-t-butylphenol), 2,2′-methylene bis(5-n-butylphenol), 2,2′-methylene bis(5-t-butylphenol), 2,2′-methylene bis(4-t-amylphenol), 2,2′-methylene bis(4-methoxyphenol), 2,2′-methylene bis(5-methoxyphenol), 2,2′-methylene bis(4-cyanophenol), 2,2′-methylene bis(5-cyanophenol), 2,2′-methylene bis(4-nitrophenol), 2,2′-methylene bis(5-nitrophenol), 2,2′-methylene bis(4-phenylphenol), 2,2′-methylene bis(5-phenylphenol), 2,2′-methylene bis(4-cumylphenol), 2,2′-methylene bis(5-cumylphenol), 2,2′-ethylidene bisphenol, 2,2′-ethylidene bis(4-chlorophenol), 2,2′-ethylidene bis(5-chlorophenol, 2,2′-ethylidene bis(4-hydroxyphenol), 2,2′-ethylidene bis(5-hydroxyphenol), 2,2′-ethylidene bis(4-methylphenol), 2,2′-ethylidene bis(5-methylphenol), 2,2′-ethylidene bis(4-ethylphenol), 2,2′-ethylidene bis(5-ethylphenol), 2,2′-ethylidene bis(4-n-propylphenol), 2,2′-ethylidene bis(4-isopropylphenol), 2,2′-ethylidene bis(5-isopropylphenol), 2,2′-ethylidene bis(4-n-butylphenol), 2,2′-ethylidene bis(4-t-butylphenol), 2,2′-ethylidene bis(5-n-butylphenol), 2,2′-ethylidene bis(5-t-butylphenol), 2,2′-ethylidene bis(4-t-amylphenol), 2,2′-ethylidene bis(4-methoxyphenol), 2,2′-ethylidene bis(5-methoxyphenol), 2,2′-ethylidene bis(4-cyanophenol), 2,2′-ethylidene bis(5-cyanophenol), 2,2′-ethylidene bis(4-nitrophenol), 2,2′-ethylidene bis(5-nitrophenol), 2,2′-ethylidene bis(4-phenylphenol), 2,2′-ethylidene bis(5-phenylphenol), 2,2′-ethylidene bis(4-cumylphenol), 2,2′-ethylidene bis(5-cumylphenol), 2,2′-(phenylmethylene) bisphenol, 2,2′-(phenylmethylene) bis(4-chlorophenol), 2,2′-(phenylmethylene) bis(5-chlorphenol), 2,2′-(phenylmethylene) bis(4-hydroxyphenol), 2,2′-(phenylmethylene) bis(5-hydroxyphenol), 2,2′-(phenylmethylene) bis(4-methylphenol), 2,2′-(phenylmethylene) bis(5-methylphenol), 2,2′-(phenylmethylene) bis(4-ethylphenol), 2,2′-(phenylmethylene) bis(5-ethylphenol), 2,2′-(phenylmethylene) bis(4-propylphenol), 2,2′-(phenylmethylene) bis(4-isopropylphenol), 2,2′-(phenylmethylene) bis(5-isopropylphenol), 2,2′-(phenylmethylene) bis(4-t-butylphenol), 2,2′-(phenylmethylene) bis(5-t-butylphenol), 2,2′-(phenylmethylene) bis(4-t-amylphenol), 2,2′-(phenylmethylene) bis(4-methoxyphenol), 2,2′-(phenylmethylene) bis(5-methoxyphenol), 2,2′-(phenylmethylene) bis(4-cyanophenol), 2,2′-(phenylmethylene) bis(5-cyanophenol), 2,2′-(phenylmethylene) bis(4-nitrophenol), 2,2′-(phenylmethylene) bis(5-nitrophenol), 2,2′-(phenylmethylene) bis(4-phenylphenol), 2,2′-(phenylmethylene) bis(5-phenylphenol) and the like.

The preferred condensation product (two ring condensation product) may include 2,2′-methylene bis(4-methylphenol), 2,2′-methylene bis(4-ethylphenol), 2,2′-methylene bis(4-isopropylphenol), 2,2′-methylene bis(4-t-butylphenol), 2,2′-methylene bis(4-n-propylphenol), 2,2′-methylene bis(4-n-butylphenol), 2,2′-methylene bis(4-t-amylphenol), 2,2′-methylene bis(4-cumylphenol), 2,2′-ethylidene bis(4-methylphenol), 2,2′-ethylidene bis(4-ethylphenol), 2,2′-ethylidene bis(4-isopropylphenol), 2,2′-ethylidene bis(4-t-butylphenol), 2,2′-ethylidene bis(4-n-butylphenol), 2,2′-ethylidene bis(4-t-amylphenol), 2,2′-ethylidene bis(4-cumylphenol), 2,2′-butylidene bis(4-methylphenol), 2,2′-butylidene bis(4-t-butylphenol) and the like. Of these, 2,2′-methylene bis(4-methylphenol), 2,2′-methylene bis(4-isopropylphenol), 2,2′-methylene bis(4-t-butylphenol), 2,2′-methylene bis(4-n-butylphenol), 2,2′-methylene bis(4-n-propylphenol), 2,2′-methylene bis(4-t-amylphenol), 2,2′-methylene bis(4-cumylphenol), 2,2′-ethylidene bis(4-t-butylphenol) and 2,2′-butylidene bis(4-t-butylphenol) are particularly preferred.

The specific examples of the 3 to 5 ring condensation product of the condensation composition represented by the chemical formula 2, which is a condensation product with n=1 to 3 having 3 to 5 phenol rings, are those corresponding to the compounds cited as specific examples of the two ring condensation product described above.

The condensation composition represented by the chemical formula 2 is preferably two ring condensation product or a mixture of condensation products containing mainly two ring condensation product and also containing at least one condensation product containing three rings to five rings.

The phrase “at least one condensation product containing three rings to five rings” signifies either (i) sole three ring condensation product, (ii) two kinds of condensation products, which are three ring condensation product and four ring condensation product, or (iii) three kinds of condensation products, which are three ring condensation product, four ring condensation product and five ring condensation product. The phrase “mainly two ring condensation products” signifies the content of two ring condensation product is the largest among the condensation products constituting the condensation composition.

The condensation composition of the present invention represented by the chemical formula 2 may contain condensation products with n is more than or equal to four, which is the condensation products having more than or equal to 6 phenol rings, as impurities, provided that these do not hamper the purpose of the present invention.

The examples of preferred condensation composition, which is a condensation composition containing mainly two ring condensation product and also containing at least one condensation product containing three rings to five rings, may include a condensation composition containing mainly those listed above as preferred examples of the condensation composition comprising the two ring condensation product and also containing the corresponding condensation products containing three rings to five rings.

In such a condensation composition, the content of the two ring condensation product is preferably from 40% to 99%, more preferably from 45% to 98%, particularly preferably from 50% to 80%. The term “%” signifies the “area %” in high performance liquid chromatography analytical results.

The desired improvements in the sensitivity of thermosensitive recording medium and storage stability of the color developed image and the background are not realized sufficiently when the content of the two ring condensation product in the condensation composition is less than 40% or greater than 99%.

As the examples of the condensation composition represented by the chemical formula 2 used in the present invention, alkyl phenol formalin condensation products such as Tomilac 224 (trade name) manufactured by API Corporation and the like, for example, can be ideally used. Such alkyl phenol formalin condensation products may be produced by using the method described in the International Publication WO 2002/098674 pamphlet etc. For example, the condensation product may be readily obtained by using a well known synthetic method in which a substituted phenol and a ketone compound or an aldehyde compound are allowed to react in the presence of an acid catalyst, which is, for example, hydrochloric acid, p-toluene sulfonic acid and the like. The reaction is allowed to occur in a suitable organic solvent that can dissolve the starting materials and reaction products and is inert to the reaction, which is, for example, water, methanol, ethanol, n-propyl alcohol, isopropyl alcohol, acetonitrile, toluene, chloroform, diethyl ether, N,N-dimethyl acetamide, benzene, chlorobenzene, dichlorobenzene, diethylketone, ethyl methyl ketone, acetone, tetrahydrofuran and the like, for several hours to several tens of hours at a reaction temperature of 0° C. to 150° C. After the reaction, the product is obtained in good yield by removing the unreacted substituted phenol using distillation.

As specific examples of the substituted phenols, phenol, p-chlorophenol, m-chlorophenol, o-chlorophenol, catechol, resorcinol, hydroquinone, p-cresol, m-cresol, o-cresol, p-ethylphenol, m-ethylphenol, o-ethylphenol, p-propylphenol, o-propylphenol, p-isopropylphenol, m-isopropylphenol, o-isopropylphenol, p-t-butylphenol, m-t-butylphenol, o-t-butylphenol, p-t-amylphenol, p-methoxyphenol, m-methoxyphenol, o-methoxyphenol, p-cyanophenol, m-cyanophenol, o-cyanophenol, p-nitrophenol, m-nitrophenol, o-nitrophenol, p-phenylphenol, m-phenylphenol, o-phenylphenol, p-cumylphenol, m-cumylphenol, o-cumylphenol, p-(α-methylbenzyl)phenol and the like may be cited.

As specific examples of the ketone and aldehyde compounds, dimethyl ketone, diethyl ketone, ethyl methyl ketone, methyl isobutyl ketone, formaldehyde, benzaldehyde and the like may be cited but are not limited to the examples.

Other color developing agent than those may also be used in combination in the thermosensitive color developing layer, provided that these do not hamper the effect of the present invention. As the color developing agent, all of the well known color developing agents used previously in pressure sensitive or thermosensitive recording media may be used with no specific restrictions. However, such color developing agent includes, for example, inorganic acidic substances such as activated clay, attapulgite, colloidal silica, inorganic acidic substances such as aluminum silicate and the like, 4,4′-isopropylidene diphenol, 1,1-bis(4-hydroxyphenyl)cyclohexane, 2,2-bis(4-hydroxyphenyl)-4-methylpentane, 4,4′-dihydroxydiphenyl sulfide, hydroquinone monobenzyl ether, benzyl 4-hydroxybenzoate, 4,4′-dihydroxy diphenyl sulfone, 2,4′-dihydroxy diphenyl sulfone, 4-hydroxy-4′-isopropxy diphenyl sulfone, 4-hydroxy-4′-n-propoxy diphenyl sulfone, 4-hydroxyphenyl-4′-benzyloxyphenyl sulfone, 3,4-dihydroxyphenyl-4′-methyl phenyl sulfone, aminobenzene sulfonamide derivatives described in Japanese Patent Application Public Disclosure No. H08-59603, bis(4-hydroxyphenyl thioethoxy)methane, 1,5-di(4-hydroxyphenyl thio)-3-oxapentane, butyl bis(p-hydroxyphenyl)acetate, methyl bis(p-hydroxyphenyl)acetate, 1,1-bis(4-hydroxyphenyl)-1-phenyl ethane, 1,4-bis[α-methyl-α-(4′-hydroxyphenyl)ethyl] benzene, 1,3-bis[α-methyl-α-(4′-hydroxyphenyl)ethyl] benzene, di(4-hydroxy-3-methylphenyl) sulfide, 2,2′-thiobis(3-tert-octylphenol), 2,2′-thiobis(4-tert-octylphenol), phenolic compounds such as diphenyl sulfone crosslinked compounds and the like described in International Publication WO97/16420, phenolic compounds described in International Publication WO02/081229 or Japanese Patent Application Public Disclosure No. 2002-301873, thiourea compounds such as N,N′-di-m-chlorophenyl thiourea and the like, p-chlorobenzoic acid, stearyl gallate, bis[zinc 4-octyloxy carbonylamino] salicylate dihydrate, 4-[2-(p-methoxyphenoxy)ethyloxy] salicylic acid, 4-[3-(p-trisulfonyl) propyloxy] salicylic acid, aromatic carboxylic acids such as 5-[p-(2-p-methoxyphenoxyethoxy) cumyl] salicylic acid and salts of these aromatic carboxylic acids and polyvalent metals such as zinc, magnesium, aluminum, calcium, titanium, manganese, tin, nickel and the like, and, furthermore, antipyrine complexes of zinc thiocyanate and complex zinc salts and the like of terephthal aldehyde acid with other aromatic carboxylic acids. These color developing agents may be used individually and in mixtures of at least two. The high molecular weight aliphatic acid metal complex salts described in Japanese Patent Application Public Disclosure No. 1110-258577 and metal chelate type color development components such as polyvalent hydroxy aromatic compounds and the like may also be present.

As the electron donating leuco dye used in the present invention, all of the well known electron donating leuco dyes used previously in pressure sensitive or thermosensitive recording media may be used with no specific restrictions. However, triphenylmethane type compounds, fluorane type compounds, fluorene type compounds, divinyl type compounds and the like are preferred. Specific examples of the typical colorless or pale dye (dye precursors) are shown below. In addition, the dye precursors may be used individually or as mixtures of at least two of them.

### <Triphenylmethane Type Leuco Dyes>

3,3-bis(p-dimethyl aminophenyl)-6-dimethylaminophthalide [alternate name: crystal violet lactone] and 3,3-bis(p-dimethyl aminophenyl) phthalide [alternate name: malachite green lactone]

### <Fluorane Type Leuco Dyes>

3-Diethylamino-6-methylfluorane, 3-diethylamino-6-methyl-7-anilinofluorane, 3-diethylamino-6-methyl-7-(o,p-dimethylanilino)fluorane, 3-diethylamino-6-methyl-7-chlorofluoran, 3-diethylamino-6-methyl-7-(m-trifluoromethylanilino) fluorane, 3-diethylamino-6-methyl-7-(o-chloroanilino) fluorane, 3-diethylamino-6-methyl-7-(p-chloroanilino) fluorane, 3-diethylamino-6-methyl-7-(o-fluoroanilino) fluorane, 3-diethylamino-6-methyl-7-(m-methylanilino) fluorane, 3-diethylamino-6-methyl-7-n-octylanilino fluorane, 3-diethylamino-6-methyl-7-n-octylamino fluorane, 3-diethylamino-6-methyl-7-benzylamino fluorane, 3-diethylamino-6-methyl-7-dibenzylamino fluorane; 3-diethylamino-6-chloro-7-methyl fluorane, 3-diethylamino-6-chloro-7-anilino fluorane, 3-diethylamino-6-chloro-7-p-methylanilino fluorane, 3-diethylamino-6-ethoxyethyl-7-anilino fluorane, 3-diethylamino-7-methyl fluorane, 3-diethylamino-7-chloro fluorane, 3-diethylamino-7-(m-trifluoromethylanilino) fluorane, 3-diethylamino-7-(o-chloroanilino) fluorane, 3-diethylamino-7-(p-chloroanilino) fluorane, 3-diethylamino-7-(o-fluoroanilino) fluorane, 3-diethylamino-benz[a] fluorine; 3-diethylamino-benz[c] fluorane, 3-dibutylamino-6-methyl-fluorane, 3-dibutylamino-6-methyl-7-anilino fluorane, 3-dibutylamino-6-methyl-7-(o,p-dimethylanilino) fluorane, 3-dibutylamino-7-(o-chloroanilino) fluorane, 3-butylamino-6-methyl-7-(p-chloroanilino) fluorane, 3-dibutylamino-6-methyl-7-(o-fluoroanilino) fluorane, 3-dibutylamino-6-methyl-7(m-fluoroanilino) fluorane, 3-di butylamino-6-methyl-chloro fluorane, 3-dibutylamino-6-ethoxyethyl-7-anilino fluorane, 3-dibutylamino-6-chloro-7-anilino fluorane, 3-dibutylamino-6-methyl-7-p-methylanilino fluorane, 3-dibutylamino-7-(o-chloro anilino) fluorane, 3-dibutylamino-7-(o-fluoroanilino) fluorane, 3-di-n-pentylamino-6-methyl-7-anilino fluorane, 3-di-n-pentylamino-6-methyl-7-(p-chloroanilino) fluorane, 3-di-n-pentylamino-7-(m-trifluoromethylanilino) fluorane, 3-di-n-pentylamino-6-chloro-7-anilino fluorane, 3-di-n-pentylamino-7-(p-chloroanilino) fluorane, 3-pyrrolidino-6-methyl-7-anilino fluorane, 3-piperidino-6-methyl-7-anilino fluorane, 3-(N-methyl-N-propylamino)-6-methyl-7-anilino fluorane, 3-(N-methyl-N-cyclohexylamino)-6-methyl-7-anilino fluorane, 3-(N-ethyl-N-cyclohexylamino)-6-methyl-7-anilino fluorane, 3-(N-ethyl-N-xylylamino)-6-methyl-7-(p-chloroanilino) fluorane, 3-(N-ethyl-p-toluidino)-6-methyl-7-anilino fluorane, 3-(N-ethyl-N-isoamylamino)-6-methyl-7-anilino fluorane, 3-(N-ethyl-N-isoamylamino)-6-chloro-7-anilino fluorane, 3-(N-ethyl-N-tetrahydrofurfurylamino)-6-methyl-7-anilino fluorane, 3-(N-ethyl-N-isobutylamino)-6-methyl-7-anilino fluorane, 3-(N-ethyl-N-ethoxypropylamino)-6-methyl-7-anilino fluorane, 3-cyclohexylamino-6-chloro fluorane, 2-(4-oxahexyl)-3-dimethylamino-6-methyl-7-anilino fluorane, 2-(4-oxahexyl)-3-diethylamino-6-methyl-7-fluorane, 2-(4-oxahexyl)-3-dipropylamino-6-methyl-7-anilino fluorane, 2-methyl-6-p-(p-dimethylaminophenyl)aminoanilino fluorane, 2-methoxy-6-p-p-dimethylaminophenyl)aminoanilino fluorane, 2-chloro-3-methyl-6-p-(p-phenylaminophenyl)aminoanilino fluorane, 2-chloro-6-p-(p-dimethylaminophenyl)aminoanilino fluorane, 2-nitro-6-p-(p-diethylaminophenyl)aminoanilino fluorane, 2-amino-6-p-(p-diethylaminophenyl)aminoanilino fluorane, 2-diethylamino-6-p-(p-diethylaminophenyl)aminoanilino fluorane, 2-phenyl-6-methyl-6-p-(p-phenylaminophenyl)aminoanilino fluorane, 2-benzyl-6-p-(p-phenylaminophenyl)aminoanilino fluorane, 2-hydroxy-6-p-(p-phenylaminophenyl)aminoanilino fluorane, 3-methyl-6-p-(p-dimethylaminophenyl)aminoanilino fluorane, 3-diethylamino-6-p-(p-diethylaminophenyl)aminoanilino fluorane, 3-diethylamino-6-p-(p-dibutylaminophenyl)aminoanilino fluorane and 2,4-dimethyl-6-[(4-dimethylamino) anilino] fluorane.

### <Fluorene Type Leuco Dye>

3,6,6-Tris(dimethylamino) spiro[fluorene-9,3′-phthalide] and 3,6,6′-tris (diethylamino) spiro [fluorene-9,3′-phthalide].

### <Divinyl Type Leuco Dyes>

3,3-bis-[2-(p-dimethyl aminophenyl)-2-(p-methoxyphenyl)ethenyl]-4,5,6,7-tetrabromophthalide, 3,3-bis-[2-(p-dimethylaminophenyl)-2-(p-methoxyphenyl)ethenyl]-4,5,6,7-tetrachlorophthalide, 3,3-bis-[1,1-bis(4-pyrolidinophenyl)ethylene-2-yl]-4,5,6,7-tetrabromophthalide and 3,3-bis-[1-(4-methoxyphenyl)-1-(4-pyrolydinophenyl)ethylene-2-yl]-4,5,6,7-tetrchlorophthalide.

### <Others>

3-4-Diethylamino-2-ethoxyphenyl)-3-(1-ethyl-2-methylindol-3-yl)-4-azaphthalide, 3-(4-diethylamino-2-ethoxyphenyl)-3-(1-octyl-2-methylindol-3-yl) azaphthalide, 3-(4-cyclohexyl ethylamino-2-methoxyphenyl)-3-(1-ethyl-2-methylindol-3-yl)-4-azaphthalide, 3,3-bis(1-ethyl-2-methylindol-3-yl)phthalide, 3,6-bis(diethylamino)fluorane-γ-(3′-nitro)anilinolactam, 3,6-bis(diethylamino)fluorane-γ-(4′-nitro) anilinolactam, 1,1-bis-[2′,2′,2″,2″-tetrakis-(p-dimethylaminophenyl)-ethenyl]-2,2-dinitrilethane, 1,1-bis-[2′,2′,2″,2″-tetrakis-(p-dimethylaminophenyl)-ethenyl]-2-β-naphthoylethane, 1,1-bis-[2′,2′,2″,2″-tetrakis-(p-dimethylaminophenyl)-ethenyl]-2,2-diacetylethane and bis-[2,2,2′,2′-tetrakis-(p-dimethylaminophenyl)-ethenyl]-methylmalonic acid dimethyl ester.

The previously well known sensitizers may be used as the sensitizer in the thermosensitive recording medium of the present invention. As such sensitizers, aliphatic acid amides such as stearic acid amide, palmitic acid amide and the like, ethylene bis-amide, montan acid wax, polyethylene wax, 1,2-di-(3-methylphenoxy)ethane, p-benzyl biphenyl, β-benzyloxy naphthalene, 4-biphenyl-p-tolyl ether, m-terphenyl, 1,2-diphenoxyethane, dibenzyl oxalate, di(p-chlorobenzyl) oxalate, di(p-methylbenzyl) oxalate, dibenzyl terephthalate, benzyl p-benzyloxy benzoate, di-p-tolyl carbonate, phenyl-α-naphthyl carbonate, 1,4-diethoxynaphthalene, 1-hydroxy-2-naphthoic acid phenyl ester, o-xylene-bis-(phenyl ether), 4-(m-methyl phenoxymethyl) biphenyl, 4,4′-ethylene dioxy-bis-benzoic acid dibenzyl ester, dibenzoyloxy methane, 1,2-di(3-methylphenoxy) ethylene, bis[2-(4-methoxy-phenoxy)ethyl]ether, methyl p-nitrobenzoate and phenyl p-toluene sulfonate may be listed as examples, but the sensitizer is not particularly limited to these examples. These sensitizers may be used individually and as mixtures of at least two of them.

As stabilizers in the present invention that impart oil resistance and the like to recorded images, 4,4′-butylidene (6-t-butyl-3-methylphenol), 2,2′-di-t-butyl-5,5′-dimethyl-4,4′-sulfonyl diphenol, 1,1,3-tris(2-methyl-4-hydroxy-5-cyclohexylphenyl) butane, 1,1,3-tris(2-methyl-4-hydroxy-5-t-butylphenyl) butane and the like may be used in combination in ranges that do not interfere with the desired effects on the tasks described above.

As a binder used in the thermosensitive recording medium of the present invention, a list of examples of which include completely saponified poly(vinyl alcohol) with a degree of polymerization of from 200 to 1900, partially saponified poly(vinyl alcohol), acetoacetylated poly(vinyl alcohol), carboxy modified poly(vinyl alcohol), amide modified poly(vinyl alcohol), sulfonic acid modified poly(vinyl alcohol), butyral modified poly(vinyl alcohol), olefin modified poly(vinyl alcohol), nitrile modified poly(vinyl alcohol), pyrolidone modified poly(vinyl alcohol), silicone modified poly(vinyl alcohol), other modified poly(vinyl alcohols, hydroxyethyl cellulose, methyl cellulose, ethyl cellulose, carboxymethyl cellulose, styrene-maleic anhydride copolymers, styrene-butadiene copolymers, cellulose derivatives such as ethyl cellulose and acetyl cellulose, casein, gum Arabic, oxidized starch, etherized starch, dialdehyde starch, esterified starch, poly(vinyl chloride), poly(vinyl acetate), polyacrylamide, poly(acrylate esters), poly(vinyl butyral), polystyrols and their copolymers, polyamide resins, silicone resins, petroleum resins, terpene resins, ketone resins, coumarone resins and the like. The polymeric substances are used upon dissolving them in a solvent such as water, alcohol, ketones, esters, hydrocarbons and the like or dispersing them in water or other media to form an emulsion or a paste and may be combined depending upon the qualities required.

As the crosslinking agent used in the present invention, glyoxal, methylol melamine, melamine formaldehyde resins, melamine urea resins, polyamine epichlorohydrin resins, polyamide epichlorohydrin resins, potassium persulfate, ammonium persulfate, sodium persulfate, ferric chloride, magnesium chloride, borax, boric acid, alum, ammonium chloride and the like may be listed as examples.

As the pigment used in the present invention, inorganic and organic fillers such as silica, calcium carbonate, kaolin, calcined kaolin, diatomaceous earth, talc, titanium oxide, aluminum hydroxide and the like may be cited.

As the slip agent used in the present invention, fatty acid metal salts such as zinc stearate, calcium stearate and the like, wax, silicone resins and the like may be cited.

In addition, ultraviolet ray absorption agents, dispersion agents, defoaming agents, oxidation inhibitors, fluorescent dye and the like may also be used.

The types and amounts of the dye, color developing agents and various other components used in the thermosensitive color developing layer of the present invention are decided according to performance and recording properties. The amounts are not particularly limited, but the color developing agent (total) is ordinarily used at about 0.5 to 10 weight parts per one part of dye, the sensitizer is used at about 0.5 to 10 weight parts, the stabilizing agent is used at about 0.01 to 10 weight parts and other components are used at about 0.01 to 10 weight parts.

The ratio of the first and second electron accepting color developing agents to the total color developing agent is preferably more than or equal to 50 weight % and it is most preferable that the color developing agent consists of the first and second electron accepting color developing agents. The weight ratio of the first electron accepting color developing agent to the second electron accepting color developing agent is more than 1 and less than or equal to 4.

The weight ratio of the first electron accepting color developing agent to the second electron accepting color developing agent is preferably more than or equal to 1.1 and less than or equal to 3.8, more preferably more than or equal to 1.2 and less than or equal to 3.6, most preferably more than or equal to 1.25 and less than or equal to 3.5. When the weight ratio of the first electron accepting color developing agent to the second electron accepting color developing agent is outside of the range above, the plasticizer resistance of the thermosensitive recording medium may possibly be poor.

The dye, color developing agent and other materials added when needed are ground into particles several microns in size or smaller using a grinder or emulsification device such as a ball mill, attriter sand grinder and the like. A binder and various additives are added depending on the objective of preparing a coating solution. Water, an alcohol and the like may be used as the solvent used to prepare the coating solution, and the solid fraction is present at about 20 wt. % to 40 wt. %.

As the method to prepare the thermosensitive color, developing layer, any of the well known method may be used with no specific restrictions. For example, the thermosensitive color developing layer may be prepared by preparing the coating solution (thermosensitive color developing layer coating solution), applying the coating solution on a substrate to form a coated layer, and drying the coated layer.

As the shape, structure, size, material and other characteristics of the substrate can be determined according to the purpose with no specific restrictions. For example, the shape may be sheet, roll, flat plate or the like. The structure may be monolayer or multilayer. The size may be determined according to the aimed application of the thermosensitive recording medium. The material may be, for example, plastic film, synthetic paper, free paper, waste paper pulp, recycled paper, luster paper, oil proof paper, coated paper, art paper, cast coated paper, weak coated paper, resin laminated paper, release paper or the like. The composite sheet combining these listed above may be used as a substrate.

The thickness (total thickness) of the substrate may be determined according to the purpose with no specific restrictions and is preferably 30 to 2,000 μm, more preferably 50 to 1,000 μm.

A protective layer may be installed on a thermosensitive color developing layer in a thermosensitive recording medium of the present invention.

The protective layer may comprise a pigment and a resin as main components and water soluble polymer, such as poly(vinyl alcohol), starch and the like, as the main component.

In the present invention, the presence of a resin containing carboxyl groups, particularly poly(vinyl alcohol) modified with carboxyl groups, and an epichlorohydrin type resin and a polyamine/polyamide type resin in the protective layer is desirable from the view point of heat, water and moist heat resistance. The mechanism can be explained as follows:

A crosslinking reaction between the carboxyl group of the resin containing carboxyl group and the amine or the amide segment of the epichlorohydrin type resin, which is a crosslinker, takes place (first water resistance process). Then, the hydrophilic segments of the polyamine/polyamide type resin and the hydrophilic crosslinked segments formed by the resin containing carboxyl group and the epichlorohydrin type resin associate by attraction and the crosslinked segment is encased by the polyamine/polyamide type resin with the hydrophobic group on the outside. That is, the hydrophilic crosslinked segment is protected from water by the hydrophobic groups (second water resistance process). Thus high water resistance can be imparted to the reaction site of the resin and the crosslinker, which is considered to result in a superior water resistance and moisture resistance of the thermosensitive recording medium.

Especially in the case when the resin containing a carboxyl group is a carboxy modified polyvinylalcohol, the polyamine/polyamide type resin and the hydrophilic segments of the carboxy modified polyvinylalcohol associate by attraction and the carboxy modified polyvinylalcohol is encased by the polyamine/polyamide type resin with the hydrophobic group on the outside and the cationic segment of the polyamine/polyamide type resin reacts with the carboxyl group of the carboxy modified polyvinylalcohol, which is considered to result in a superior water resistance and heat resistance of the thermosensitive recording medium.

The thermosensitive recording medium has a three dimensional crosslinked structure as a result of the crosslinking reaction between the carboxy modified polyvinylalcohol and the epichlorohydrin type resins. And when the protective layer contains a pigment, the polyamine/polyamide type resin which has a cationic property shows a dispersion effect on the pigment, which makes the protective layer porous. Then the pores of the porous protective layer adsorb the melt material with a low heat resistance, which brings a good printing run-ability (head debris resistance and sticking resistance).

Now, the combined use of the epichlorohydrin type resin and the polyamine/polyamide type resin in the protective layer of the present invention is desirable. Adequate water resistance cannot be obtained when they are individually used, and other problems such as blocking are encountered. In addition, adequate water resistance cannot be obtained even when the epichlorohydrin type resin or the polyamine/polyamide type resin is used in combination with other common crosslinking agent, such as glyoxal.

The resin containing carboxyl groups used as the binder in a protective layer in the present invention may be any one as long as it contains mainly carboxyl groups. For example, a resin that contains monofunctional acrylic monomer containing carboxyl groups such as methacrylic acid, 2-hydroxyethyl methacrylate, 2-hydroxypropyl methacrylate, dimethyl aminoethyl methacrylate, diethyl aminoethyl methacrylate, t-butyl aminoethyl methacrylate, glycidyl methacrylate, tetrahydro furfuryl methacrylate and the like, oxidized starch, carboxymethyl cellulose, poly(vinyl alcohol) modified with carboxyl groups obtained by introducing carboxyl groups to poly(vinyl alcohol) and the like may be cited. However, the use of a carboxy modified poly(vinyl alcohol) with excellent heat and solvent resistance is particularly preferred.

The carboxy modified poly(vinyl alcohol) used in the present invention is a water soluble polymer into which carboxyl groups have been introduced for the purpose of enhancing the reactivity and is a reaction product of poly(vinyl alcohol) with a polyvalent carboxylic acid such as fumaric acid, phthalic anhydride, mellitic anhydride, itaconic anhydride and the like or an ester of the reaction product, or a saponified copolymer of vinyl acetate with a dicarboxylic acid with ethylene type unsaturation such as maleic acid, fumaric acid, itaconic acid, crotonic acid, acrylic acid, methacrylic acid and the like. More specifically, the product is obtained using the production process listed as examples in, for example, Japanese Patent Application Public Disclosure No. S53-91995.

Furthermore, the carboxy modified poly(vinyl alcohol) used in the present invention has a low Hercules viscosity. That is, the material is very fluid under high shear conditions but is viscous under low shear force conditions. For that reason, a coating fluid spreads smoothly when applied but forms a coating layer that solidifies immediately after application, is uniform and smooth. Thus the image quality of printed images and sensitivity are thought to improve. In addition, carboxy modified poly(vinyl alcohol) has excellent water retention, and the binder penetration into the support material can be suppressed. The feature allows a smooth coating layer to form and is thought to improve image quality and sensitivity.

The degree of polymerization and saponification of the carboxy modified poly(vinyl alcohol) used in the present invention may be appropriately selected based on the water retention of the coating and the surface strength of the coating layer.

As specific examples of the epichlorohydrin type resin used in the present invention, polyamide epichlorohydrin resins, polyamine epichlorohydrin resins and the like may be cited and may be used individually or jointly. In addition, as the amine present in the main chain of the epichlorohydrin type resin, primary to quaternary amines may be used without particular restrictions. Furthermore, a degree of cationization of 5 meq/g·solid or less (measured at pH 7) and a molecular weight of at least 500,000 are preferred based on good water resistance. As specific examples, Sumirez resin 650 (30), Sumirez resin 675A, Sumirez resin 6615 (all manufactured by Sumitomo Kagaku), WS 4002, WS 4020, WS 4024, WS 4030, WS 4046, WS 4010, CP 8970 (all manufactured by Seiko PMC Corporation) and the like may be cited.

In the present invention, the polyamine/polyamide type resin signifies a polyamine type resin and/or a polyamide type resin. And the polyamine/polyamide type resin includes polyamine resins, polyamide resins, polyamide urea type resins, poly(ethylene imine) resins, polyalkylene polyamine resins, polyalkylene polyamide resins, polyamine polyurea type resins, modified polyamine resins, modified polyamide resins, polyalkylene polyamine urea formalin resins, polyalkylene polyamine polyamide polyurea resins and the like. As specific examples, Sumirez resin 302 (a polyamine polyurea type resin manufactured by Sumitomo Chemical Co. Ltd.), Sumirez resin 712 (a polyamine polyurea type resin manufactured by Sumitomo Chemical Co. Ltd.), Sumirez 703 (a polyamine polyurea type resin manufactured by Sumitomo Chemical Co. Ltd.), Sumirez 636 (a polyamine polyurea type resin manufactured by Sumitomo Chemical Co. Ltd.), Sumirez resin SPI-100 (a modified polyamine resin manufactured by Sumitomo Chemical Co. Ltd.), Sumirez resin SPI-102A (a modified polyamide resin manufactured by Sumitomo Chemical Co. Ltd.), Sumirez resin SPI-106N (a modified polyamide resin manufactured by Sumitomo Chemical Co. Ltd.), Sumirez resin SPI-203(50) (a polyamide resin manufactured by Sumitomo Chemical Co. Ltd.), Sumirez resin SPI-198 (a polyamide resin manufactured by Sumitomo Chemical Co. Ltd.), Printive A-600 (manufactured by Asahi Kasei Corporation), Printive A-500 (manufactured by Asahi Kasei Corporation), PA 6500 (polyalkylene polyamine urea formalin resin manufactured by Seiko PMC Corporation), PA 6504 (polyalkylene polyamine urea formalin resin manufactured by Seiko PMC Corporation), PA 6634, PA 6638, PA 6640, PA 6644, PA 6646, PA 6654, PA6702, PA 6704 (all polyalkylene polyamine polyamide polyurea resin manufactured by Seiko PMC Corporation), CP 8994 (a polyethylene imine resin manufactured by Seiko PMC Corporation) and the like may be cited. Although there are no particular restrictions, the use of polyamine resins, polyalkylene polyamine resins, polyamine polyurea type resins, modified polyamine resins, polyalkylene polyamine urea formalin resins or polyalkylene polyamine polyamide polyurea resins is desirable in view of color developing sensitivity.

The concentrations of the epichlorohydrin type resin and polyamine/polyamide type resin used in the present invention are preferably 1 to 100 parts by weight, more preferably 5 to 50 parts by weight, respectively, per 100 parts by weight of the carboxy modified poly(vinyl alcohol). When the concentrations are too low, the crosslinking reaction is inadequate and good water resistance cannot be obtained. When the concentrations are too high, operational problems are experienced due to viscosity increases in the coating solution and gel formation. In addition, epichlorohydrin type resins undergo crosslinking reactions at pH of 6.0 or higher, and the pH of the protective layer coating is preferably adjusted to 6.0 or higher.

The types and amounts of various components used in the protective layer of the present invention are decided according to the performance and recording properties. The amounts are not particularly limited, but the poly(vinyl alcohol) is ordinarily used at 10 to 500 parts by weight per 100 parts by weight of the pigment and the crosslinking agent component is used at 1 to 100 parts by weight per 100 parts by weight of the poly(vinyl alcohol).

The materials are ground into fine particles several microns or smaller in size using a grinder or suitable emulsification device such as a ball mill, an attriter, a sand grinder and the like. A binder and various additives are added depending on the objective to prepare a coating solution. Water, alcohol and the like may be used as the solvent to prepare the coating solution, and the solid fraction is present at about 20 wt. % to 40 wt. %.

The pigment used in a protective layer of the present invention may be kaolin, (calcined) kaolin, calcium carbonate, aluminum oxide, titanium oxide, magnesium carbonate, aluminum silicate, magnesium silicate, calcium silicate, aluminum hydroxide, diatomaceous earth, talc and the like. The concentrations of the pigment and binder in the protective layer of the present invention are about 30 to 300 parts by weight in terms of the solid fraction of the binder per 100 parts by weight of the pigment.

The installation of an undercoating layer containing pigments, polymer substances and the like under the thermosensitive recording layer is desirable for the purpose of enhancing the color developing sensitivity in the thermosensitive recording medium of the present invention. In addition, a back coating layer can be installed on the support medium surface opposite to the surface on which a thermosensitive recording layer is applied to correct the curl. An intermediate layer (heat insulation layer) may be installed between the substrate and the thermosensitive color developing layer, between the thermosensitive color developing layer and the protective layer, or between the substrate and the back coating layer. In addition, a variety of well known techniques used in the thermosensitive recording media field such as, for example, super calendar smoothing treatments and the like can be appropriately applied after individual layers are applied.

### EXAMPLES

The following examples will illustrate the present invention, but these are not intended to restrict the present invention.

In the examples and comparative examples below, an undercoating layer, a thermosensitive color developing layer (a recording layer) and a protective layer were formed on one side of a substrate, and a back coating layer was formed on the other side of the substrate.

The each coating solution for a thermosensitive recording medium was prepared as described below.

In the description, the terms parts and % indicate parts by weight and weight %, respectively.

The composition of the second electron accepting color developing agent, which is the condensation composition represented by the chemical formula 2 was determined by the analysis using a high-performance liquid chromatography (HPLC) and is shown by the ratio (area %) of the area of each component to the total area of all components.

Condition: column: Inertsil ODS-2 (particle size: 5 micron, column: 4.6 mmφ×15 cm), eluant: aceto-nitrile: 0.05 vol % water solution of phosphoric acid=98:2 (vol), flow rate: 0.8 mL/min, wavelength: 280 nm, injected amount: 1.0 micro L, temperature of column: 40 degree C, time for analysis: 25 min., concentration of sample: about 2500 ppm

### Undercoating Layer Coating Solution

| | | |
|---|---|---|
| Calcined kaolin (Ansilex 90 manufactured by | 90 | parts |
| BASF Co.) | | |
| Styrene-butadiene copolymer latex (solid | 10.0 | parts |
| content: 50%) | | |
| Water | 50.0 | parts |

The mixture comprising the composition described above was blended and agitated to prepare an undercoating layer coating solution.

### Thermosensitive Color Developing Layer Coating Solution

The solutions A through D were separately wet ground using sand grinders until the average particle size was 0.5 μm.

Solution A (First Color Developing Agent Dispersion)

| | |
|---|---|
| Bis (3-allyl-4-hydroxyphenyl) sulfone (TGSH | 6.0 parts |
| manufactured by Nippon Kayaku Co., Ltd.) | |
| 10% Aqueous solution of poly(vinyl alcohol) | 5.0 parts |
| Water | 1.5 parts |

Solution B (Second Color Developing Agent Dispersion)

| | |
|---|---|
| Alkylphenol formalin condensation product | 6.0 parts |
| (Tomilac 224 manufactured by API Corporation) | |
| 10% Aqueous solution of poly(vinyl alcohol) | 5.0 parts |
| Water | 1.5 parts |

Solution C (Basic Colorless Dye Dispersion)

| | |
|---|---|
| 3-Dibutylamino-6-methyl-7-anilinofluorane (ODB-2 | 6.0 parts |
| manufactured by Yamamoto Kasei K.K.) | |
| 10% Aqueous solution of poly(vinyl alcohol) | 5.0 parts |
| Water | 1.5 parts |

Solution D (Sensitizer Dispersion)

| | |
|---|---|
| 1,2-Di-(3-methylphenoxy) ethane (KS232 | 6.0 parts |
| manufactured by Sanko Co., Ltd.) | |
| 10% Aqueous solution of poly(vinyl alcohol) | 5.0 parts |
| Water | 1.5 parts |

Next individual dispersions were blended in the proportions described below to prepare a thermosensitive color developing layer coating solution.

| | |
|---|---|
| Solution A and B total (color developing agent | 36.0 parts |
| dispersion) | |
| Solution C (basic colorless dye dispersion) | 18.0 parts |
| Solution D (sensitizer dispersion) | 36.0 parts |
| Silica (P537, 25% dispersion, manufactured by | 17.5 parts |
| Mizusawa Industrial Chemicals, Ltd.) | |
| Poly(vinyl alcohol) (10% solution) | 25.0 parts |

### Protective Layer Coating Solution

| | |
|---|---|
| 50% Aluminum hydroxide dispersion (Martifin OL | 9.0 parts |
| manufactured by Martinswerg) | |
| Carboxy modified poly(vinyl alcohol) (KL318 | 30.0 parts |
| manufactured by Kuraray Co., Ltd. degree of | |
| polymerization about 1,700, degree of | |
| saponification 95 to 99 mol %) 10% aqueous | |
| solution | |
| Polyamide epichlorohydrin resin (WS4030 | 4.0 parts |
| manufactured by Seiko PMC Corporation, solid | |
| fraction 25%, degree of cationization 2.7, | |
| molecular weight 2,200,000, a quaternary amine) | |
| Modified polyamine resin (Sumirez Resin SPI-102A | 2.2 parts |
| manufactured by Sumitomo Chemical Co., Ltd. solid | |
| fraction 45%) | |
| Zinc stearate (HydrinZ-7-30 manufactured by | 2.0 parts |
| Chukyo Yushi Co., Ltd. solid fraction 30%) | |

### Example 1

An undercoating layer coating solution was applied to one side of a free paper (47 g/m² substrate) using a Mayer bar at a coating rate of 10.0 g/m² and was dried (for 2 minutes using a forced air dryer at 60° C.) to prepare an undercoated paper. A thermosensitive color developing layer coating solution was prepared with 28 parts of Solution A and 8 parts of Solution. Then the thermosensitive color developing layer coating solution was applied on the undercoating layer of the undercoated paper at a coating rate of 6.0 g/m² and dried (for 2 minutes using a forced air dryer at 60° C.). The sheet was super calendared to a degree of smoothness of 500 to 1,000 seconds to yield a thermosensitive recording medium.

### Example 2

A thermosensitive recording medium was prepared in the same manner described in Example 1 with the exception that the amount of Solution A was changed to 20 parts and the amount of solution B was changed to 16 parts.

### Example 3

A thermosensitive recording medium was prepared in the same manner described in Example 2 with the exception that the amount of silica added to the thermosensitive color developing layer coating solution was changed to 7.5 parts. A protective layer coating solution was applied on the thermosensitive color developing layer at a coating rate of 3 g/m² and was dried (for 2 minutes using a forced air dryer at 60° C.) to prepare a thermosensitive recording medium.

### Comparative Example 1

A thermosensitive recording medium was prepared in the same manner described in Example 1 with the exception that the amount of Solution A was changed to 32 parts and the amount of solution B was changed to 4 parts.

### Comparative Example 2

A thermosensitive recording medium was prepared in the same manner described in Example 1 with the exception that the amount of Solution A was changed to 15 parts and the amount of solution B was changed to 21 parts.

### Comparative Example 3

A thermosensitive recording medium was prepared in the same manner described in Example 1 with the exception that the amount of Solution A was changed to 36 parts and Solution B was not used.

### Comparative Example 4

A thermosensitive recording medium was prepared in the same manner described in Example 1 with the exception that the amount of Solution B was changed to 36 parts and Solution A was not used.

### Comparative Example 5

A thermosensitive recording medium was prepared in the same manner described in Example 1 with the exception of changing both color developing agents in Solution A and B to 4-hydroxy-4′-iso-propoxy diphenyl sulfone (prepared according to the method described in Japanese patent No. 2500532).

### Comparative Example 6

A thermosensitive recording medium was prepared in the same manner described in Example 2 with the exception of changing the color developing agent in Solution B to 4-hydroxy-4′-iso-propoxy diphenyl sulfone (prepared according to the method described in Japanese patent No. 2500532).

### Comparative Example 7

A thermosensitive recording medium was prepared in the same manner described in Example 1 with the exception of changing the color developing agent in Solution A to 4,4′-di-hydroxy diphenyl sulfone (BPS manufactured by Nicca Chemical Co., Ltd.).

### Comparative Example 8

A thermosensitive recording medium was prepared in the same manner described in Example 2 with the exception of changing the color developing agent in Solution A to 4,4′-di-hydroxy diphenyl sulfone (BPS manufactured by Nicca Chemical Co., Ltd.).

### Comparative Example 9

A thermosensitive recording medium was prepared in the same manner described in Example 1 with the exception of changing the color developing agent in Solution A to 4-hydroxy-4′-n-propoxy diphenyl sulfone (Tomilac KN manufactured by API Corporation)

### Comparative Example 10

A thermosensitive recording medium was prepared in the same manner described in Example 2 with the exception of changing the color developing agent in Solution A to 4-hydroxy-4′-n-propoxy diphenyl sulfone (Tomilac KN manufactured by API Corporation)

The thermosensitive recording media obtained in the examples and comparative examples above were subjected to the following evaluations.

### <Printing Density>

A thermosensitive recording medium printer TH-PMD manufactured by Ohkura Engineering Co., Ltd. was used to print checks at an applied energy of 0.35 mJ/dot. The color developed section was examined using a Macbeth Densitometer.

### <Plasticizer Resistance>

Dia Wrap (manufactured by Mitsubishi Plastics, Inc.) was brought in contact with the front and back of the thermosensitive recording medium printed in the printing density test and was left standing for 24 hours in an environment where the temperature was 40° C. and humidity was 90%. The print density (intensity of the printed section) of the color developed section was measured, and the image remaining rate was calculated using the values before and after the test.

Image remaining rate=(print section intensity after testing)/(print section intensity before testing)×100(%)

### Rating:

Excellent: Image remaining rate is at least 90%

Good: Image remaining rate is at least 75% but less than 90%

Fair: Image remaining rate is at least 50% but less than 75%

Poor: Image remaining rate is less than 50%

### <Heat Resistance>

A blank paper sample was left standing for 24 hours in an environment where the temperature was 80° C. and the color development intensity was measured before and after the test. The background color development value was obtained.

Background color development value=developed color intensity after the test−developed color intensity before the test

### Rating:

Excellent: Developed background color is less than 0.1

Good: Developed background color is at least 0.1 but less than 0.3

Fair: Developed background color is at least 0.3 but less than 0.5

Poor: Developed background color is at least 0.5

The results are shown in the tables below.

TABLE 1

| | Printing | Plasticizer | Heat |
|---|---|---|---|
| | density | resistance | resistance |
| Example 1 | 1.45 | Excellent | Good |
| Example 2 | 1.48 | Excellent | Good |
| Example 3 | 1.45 | Excellent | Good |

TABLE 2

| | Printing | Plasticizer | Heat |
|---|---|---|---|
| | density | resistance | resistance |
| Comparative Example 1 | 1.35 | Fair | Good |
| Comparative Example 2 | 1.48 | Fair | Good |
| Comparative Example 3 | 1.34 | Excellent | Good |
| Comparative Example 4 | 1.51 | Poor | Good |
| Comparative Example 5 | 1.42 | Fair | Poor |
| Comparative Example 6 | 1.35 | Fair | Fair |
| Comparative Example 7 | 1.29 | Poor | Good |
| Comparative Example 8 | 1.35 | Poor | Good |
| Comparative Example 9 | 1.42 | Poor | Fair |
| Comparative Example 10 | 1.45 | Poor | Good |

From Tables 1 and 2, the thermosensitive recording medium showed superior printing density, plasticizer resistance and heat resistance, when the thermosensitive color developing layer contains two kinds of color developing agents at a specific range of ratio.

What is claimed is:

1. A thermosensitive recording medium having a thermosensitive color developing layer comprising a colorless or pale colored electron donating leuco dye and an electron accepting color developing agent on a substrate, wherein the thermosensitive color developing layer contains
(1) bis(3-allyl-4-hydroxyphenyl) sulfone as a first electron accepting color developing agent, and
(2) a condensation composition represented by the chemical formula 1 as a second electron accepting color developing agent: 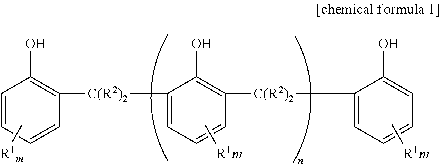
wherein R¹, which may be identical to or different from the others, represents a hydrogen atom, a halogen atom, a hydroxyl group, a lower alkyl group, an alkoxyl group, a cyano group, a nitro group, an aryl group or an aralkyl group, R², which may be identical to or different from the others, represents a hydrogen atom, an alkyl group or an aryl group, m represents an integer of 0 to 3 and n represents an integer of 0 to 3,
wherein the weight ratio of the first electron accepting color developing agent to the second electron accepting color developing agent is more than 1 and less than or equal to 4.

2. The thermosensitive recording medium of claim 1 wherein the thermosensitive recording medium has a protective layer on the thermosensitive color developing layer and the protective layer comprises (a) a resin containing a carboxyl group, (b) an epichlorohydrin type resin and (c) a polyamine/polyamide type resin.

3. The thermosensitive recording medium of claim 2 wherein the (c) a polyamine/polyamide type resin is one of polyamine resins, polyalkylene polyamine resins, polyamine polyurea resins, modified polyamine resins, polyalkylene polyamine urea formalin resins, and polyalkylene polyamine polyamide polyurea resins.

4. The thermosensitive recording medium of claim 2, wherein the (a) resin containing a carboxyl group is carboxy modified polyvinylalcohol.

5. The thermosensitive recording medium of claim 3, wherein the (a) resin containing a carboxyl group is carboxy modified polyvinylalcohol.
